(19) United States
(12) Patent Application Publication
(10) Pub. No.: US 2011/0258267 A1
(43) Pub. Date: Oct. 20, 2011

(54) VEHICLE-MOUNTED DEVICE, INFORMATION COMMUNICATION SYSTEM, METHOD FOR CONTROLLING VEHICLE-MOUNTED DEVICE AND PROGRAM THEREFOR

(75) Inventors: Akihiro Tozaki, Kanagawa (JP); Takehiko Shioda, Kanagawa (JP); Kazunori Hashimoto, Saitama (JP); Kunihiro Minoshima, Kanagawa (JP); Nobuhiro Ishizuka, Kanagawa (JP); Ken Murayama, Kanagawa (JP); Junichi Shirakawa, Osaka (JP); Shuji Daioku, Osaka (JP); Nobuo Kusumoto, Osaka (JP); Akira Tojima, Osaka (JP)

(73) Assignees: SHARP KABUSHIKI KAISHA, Osaka (JP); PIONEER CORPORATION, Kanagawa (JP)

(21) Appl. No.: 12/998,074

(22) PCT Filed: Jul. 30, 2009
(86) PCT No.: PCT/JP2009/003621

§ 371 Date: Jul. 13, 2011

(30) Foreign Application Priority Data
Sep. 16, 2008 (JP) 2008-235989

(51) Int. Cl. G06F 15/16

(52) U.S. Cl. 709/206

(57) ABSTRACT

A vehicle-mounted device or the like is provided by which a content of an electronic mail can be notified by a driver without disturbing safety driving. A vehicle-mounted device 10 has: a communication unit 110 which communicates with a portable device having an electronic mail function; an electronic mail obtaining unit 120 which obtains from the portable device 30 an electronic mail received by the portable device 30; a mail output length calculation unit 150 which calculates mail output length which is output length of the obtained electronic mail text; a destination setting unit 180 which sets a destination; and a text output unit 220 which displays or outputs audibly the electronic mail text based on the mail output length calculated by the mail output length calculation unit 150 and a predetermined condition corresponding to the destination set by the destination setting unit 180.

### TECHNICAL FIELD

The present invention relates to a vehicle-mounted device which has an obtaining function of an electronic mail, an information communication system, a method for controlling the vehicle-mounted device and a program therefor.

### BACKGROUND ART

Generally, a vehicle-mounted device has been known which has a reception unit for an electronic mail and a notification unit which notifies a driver that an electronic mail has been received (for example, patent document 1). Regarding the vehicle-mounted device described in the patent document 1, if a received notification is given when a vehicle is coming closer to a foregoing vehicle, the driver is distracted by the notification, leading to bad influence on safety driving. In such a case, the device limits the received notification to the driver.

[Patent Document 1] JP-A-2005-1533

### DISCLOSURE OF THE INVENTION

### Problems to be Solved

A vehicle-mounted device which is capable of obtaining an electronic mail having a function by which a text of the electronic mail is displayed or output audibly (read out) has been known. However, in a case that an electronic mail is long and the text thereof is output as it is, it is not preferable because bad influence is exerted against safety driving. Thus, in a vehicle-mounted device, concern for safety driving is indispensable when reception of an electronic mail and the content thereof is notified to a driver, while specific measures have not been taken yet for a text output.

In view of the problem above, the invention provides a vehicle-mounted device which can notify a content of an electronic mail to a driver without interfering safety driving as possible, an information communication system, a method for controlling the vehicle-mounted device and a program therefor.

### Means to Solve the Problems

A vehicle-mounted device of the invention has: an electronic mail obtaining unit that obtains an electronic mail; a mail output length calculation unit that calculates mail output length which is output length of the obtained electronic mail text; a destination setting unit that sets a destination; and a text output unit that displays or outputs audibly the electronic mail text based on the mail output length calculated by the mail output length calculation unit and a predetermined condition corresponding to the destination set by the destination setting unit.

A method of controlling a vehicle-mounted device of the invention is the method for controlling the vehicle-mounted device having an electronic mail obtaining function. The vehicle-mounted device executes steps of: obtaining an electronic mail; calculating mail output length that is output length of the obtained electronic mail text; setting a destination; and outputting by displaying or outputting audibly the electronic mail text based on the mail output length by calculating the mail output length and a predetermined condition corresponding to the destination by setting the destination.

With these configurations, since the electronic mail text is displayed or output audibly based on a calculation result for the mail output length and a predetermined condition corresponding to the destination (that is, a defined condition in accordance with the set destination), it is possible to reduce influence on safety driving. For example, when the mail output length is long, the electronic mail text may be displayed or output audibly so as to shorten time needed for confirming the content thereof by a driver.

The “electronic mail obtaining unit (obtaining an electronic mail)” may obtain an electronic mail transferred from an outside device (such as a portable telephone) having an electronic mail function, or may obtain an electronic mail by receiving it directly.

The “mail output length (output length of the electronic mail text)” indicates a size of a display region needed for displaying the electronic mail text, display time, or output time needed for outputting audibly the electronic mail text. The size of the display region and the output time can be calculated by a predetermined algorithm having parameters such as the number of letters included in an electronic mail, data amount, existence/non-existence of an attached file.

The meaning of “displays or outputs audibly the electronic mail text based on the mail output length and the predetermined condition” is such that changing a state of whether output is made, limitation for output target, output speed and output style. As the output style, an output order, output size (when in displaying), letter decoration (when in displaying), output volume (when in audio output) and output voice (when in audio output) may be changed.

Further, “the vehicle-mounted device” includes devices (portable type on-board device) detachably provided on a vehicle, besides devices fixed mounted on the vehicle.

In the vehicle-mounted device described above, the device further has a required time calculation unit that calculates required time for driving from a current position to the set destination, and the predetermined condition is the required time calculated by the required time calculation unit.

With these configurations, it is possible to output the electronic mail text effectively based on the mail output length and the required time to the destination. For example, by determining an output speed at which a whole electronic text can be output within a predetermined time frame, a driver can be free from burden by which the driver has to continue to confirm an output of the electronic mail text even if the driver has arrived at the destination.

In a case that a plurality of driving routes to the set destination exist, it is preferable that the required time be calculated based on the set driving route by urging the driver to set (select) the driving route. With this configuration, it is possible to calculate more accurate required time.

In the vehicle-mounted device described above, the device further has a route guidance unit that guides a route to the set destination. The route guidance unit has a guidance information output unit that displays or outputs audibly guidance information at predetermined timing. The predetermined condition is output timing of the guidance information.

In the vehicle-mounted device described above, the text output unit outputs the electronic mail text before or after the guidance information when output of the electronic mail text overlaps with the output timing of the guidance information.

With these configurations, it is possible to give influence on information outputs to each other by outputting the electronic mail text based on the mail output length and the output timing of guidance information. For example, when the electronic mail text output overlaps with the output timing of the guidance information, by outputting the electronic mail text before or after outputting the guidance information, it is possible to avoid the problem in which a driver can not correctly confirm the both pieces of information due to the overlap. The output timing of the guidance information usually can not be changed. By adjusting output timing of the electronic mail text, it is possible to prevent inaccurate guidance information (having a sense of discomfort) from being output.

The “guidance information” includes route guidance information such as “turn right at 300 m ahead” and “right direction soon”, time guidance information such as “three o'clock”, and traffic information such as “traffic jam at 300 m ahead”.

It is preferable that the “output timing of guidance information” be edited as needed based on a traffic jam state in driving and a driving speed. With this configuration, inaccurate guidance information can not be output. The “guidance information” may be edited in place of the “output timing”. For example, in a case that guidance information of “turn right at 300 m ahead” is supposed to be output at predetermined timing (predetermined time) and the vehicle can not arrive at the right turn point by the predetermined time due to a traffic jam, the device can correspond the situation by editing the guidance information as “turn right at 500 m ahead”.

In the vehicle-mounted device described above, the text output unit displays or outputs audibly a remaining portion other than output completed portion of the electronic mail after arriving at the destination when the electronic mail text output has not been completed by the arrival to the destination.

With this configuration, when the electronic mail text output has not been completed by the arrival to the destination, it is possible to continue the remaining portion to be output after the arrival to the destination.

Regarding “whether the electronic mail text output is completed by the arrival to the destination”, it may be discriminated at the setting of the destination, or may be discriminated at predetermined timing (periodically or after outputting the guidance information) in consideration of the required time to the destination and the output timing of the guidance information.

Since there is no need to worry about safety aspect in terms of outputting the “remaining portion of the electronic mail” after the arrival to the destination, it is preferable that it be output both on a display and by audio output to focus on quick and correct confirmation by the driver. Based on the driver's convenience, the driver may instruct fast-forward output and the like.

In the vehicle-mounted device described above, the text output unit begins to output from a beginning of a sentence or a paragraph to which an initial letter of the remaining portion belongs when the remaining portion of the electronic mail is output.

With this configuration, in a case that the driver confirms the “remaining portion of the electronic mal after arriving at the destination, a problem such that the driver feels a sense of discomfort or can not correctly understand when the output begins from the middle of a sentence or a paragraph can be avoided.

In the vehicle-mounted device described above, the device further has a communication device that communicates with a portable device having an electronic mail function, and the electronic mail obtaining unit obtains from the portable device an electronic mail received by the portable device.

With this configuration, it is possible to adopt the invention to a vehicle-mounted device without an electronic mail reception function by coordinating with the portable device.

In the vehicle-mounted device described above, the communication device sends output completion information indicating a mail ID of the electronic mail output from the text output unit to the portable device, and the output completion information is information that renders the electronic mail corresponding to the mail ID in an already-read state in accordance with receiving the output completion information by the portable device.

In the vehicle-mounted device described above, the output completion information is information that renders an output completed portion of the electronic mail corresponding to the mail ID in the already-read state.

With these configurations, since the output completed portion which has been output completely at the vehicle-mounted device can be rendered in the already-read state by the portable device, the driver can recognize the electronic mail already read and the already-read portion thereof. With this configuration, a burden by which the driver has to confirm the same electronic mail again at the portable device even if the electronic mail has been already read at the vehicle-mounted device can be avoided.

In the vehicle-mounted device described above, the device further has an importance degree discrimination unit that discriminates importance degree of the electronic mail, and the text output unit displays or outputs audibly the electronic mail text based on the mail output length, the predetermined condition and the importance degree discriminated by the importance degree discrimination unit.

With this configuration, it is possible to display or outputs audibly in accordance with the importance degree of the electronic mail.

In the vehicle-mounted device described above, the importance degree discrimination unit discriminates importance degree of the electronic mail based on at least one pieces of information among a priority flag added to the electronic mail, a sender's address and existence/nonexistence for breaking a seal confirmation.

With this configuration, it is easily possible to discriminate the importance degree based on the priority flag added to the electronic mail, the sender's address, the existence/nonexistence for breaking a seal confirmation and the like.

The “sender's address” including a predetermined character string in the address may be discriminated as having high importance degree, or the importance degree thereof may be discriminated whether it has been stored in a telephone book in the portable device or the vehicle-mounted device.

In the vehicle-mounted device described above, the device further has a mail output length discrimination unit that discriminates whether the calculated mail output length exceeds predetermined output length, and the text output unit displays or outputs audibly only a beginning portion of the electronic mail text when the mail output length exceeds the predetermined output length.

With this configuration, since only the beginning portion is output, which leads to shorten the time needed for output. Therefore, it is possible to reduce influence on safety driving. Since a beginning portion includes important content (summary) of an electronic mail text in many cases, a function such that the content of an electronic mail is notified to a driver is surely made even if only a beginning portion is output.

The “beginning portion” may be predetermined output length from the beginning of an electronic mail, or a predetermined ratio such as a former portion when an electronic mail text is divided into the former portion and a latter portion (½ of the whole).

In the vehicle-mounted device described above, the device further has an output instruction unit that instructs to output a remaining portion other than the beginning portion of the electronic mail text, and the text output unit displays or outputs audibly the remaining portion when the output instruction unit instructs.

With this configuration, in a case that a driver would like to confirm not only a beginning portion but also a whole text depending on the context of an electronic mail, this can be easily achieved.

An information communication system of the invention has the vehicle-mounted device described above and a portable device.

A program of the invention executes a computer to perform each step in the method for controlling the vehicle-mounted device described above.

With these configuration, it is possible to provide an information communication system and a program which can notify the content of an electronic mail to a driver without interfering safety driving as possible.

### BRIEF DESCRIPTION OF THE DRAWINGS

FIG. 1 is a control block diagram of a vehicle-mounted device according to one embodiment of the invention.

FIG. 2 is a functional block diagram of an information communication system according to the first embodiment.

FIG. 3 is a display example of instruction screen which displays whether the remaining portion of an electronic mail text should be output.

FIG. 4 is a sequence diagram showing an outline of an electronic mail reading-out process between the vehicle-mounted device and a portable device.

FIG. 5 is a flowchart of the reading-out process of the vehicle-mounted device according to the first embodiment.

FIG. 6 is a functional block diagram of the information communication system according to the second embodiment.

FIG. 7 is a flowchart of the reading-out process of the vehicle-mounted device according to the second embodiment.

FIG. 8 is a functional block diagram of the information communication system according to the third embodiment.

FIG. 9 is a flowchart of the reading-out process of the vehicle-mounted device according to the third embodiment.

### BEST MODES FOR CARRYING OUT THE INVENTION

A vehicle-mounted device, an information communication system, a method for controlling communication of the vehicle-mounted device and program therefor according to one embodiment of the invention will be described hereinafter. In the embodiments, an information device having a communication function (especially, an electronic mail obtaining function) with a portable device (such as a mobile phone) and a car navigation function is exemplified as a vehicle-mounted device.

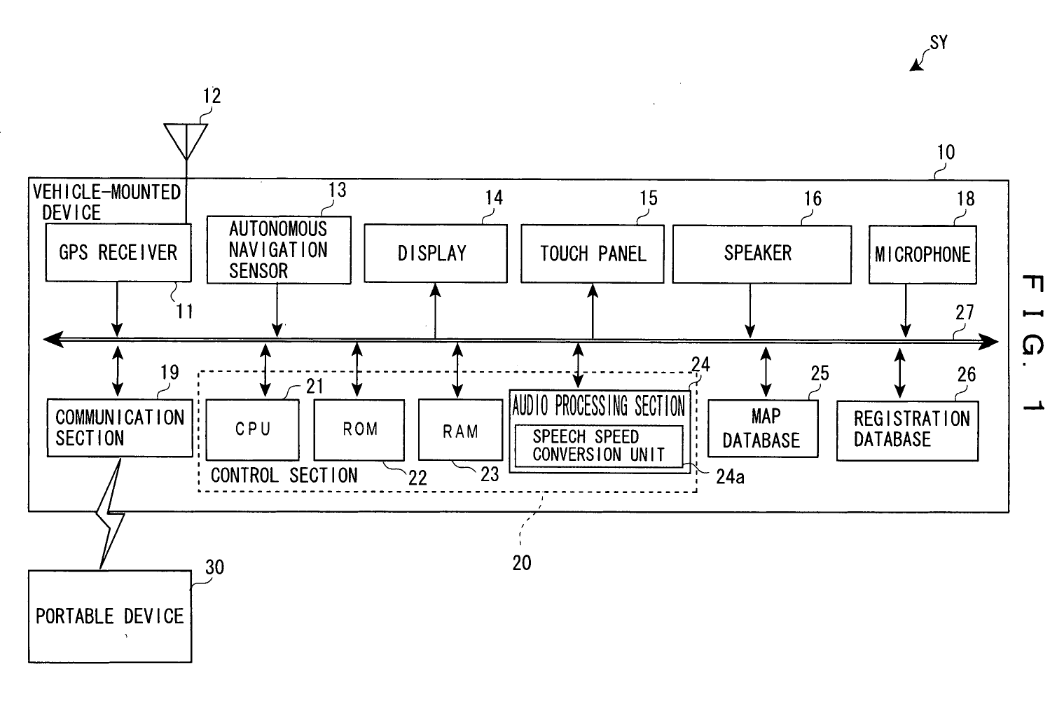

FIG. 1 is a control block diagram of a vehicle-mounted device 10. As shown in FIG. 1, the vehicle-mounted device 10 includes a GPS (Global Positioning System) receiver 11, an antenna 12, an autonomous navigation sensor 13, a display 14, a touch panel 15, a speaker 16, a microphone 18, a communication section 19, a control section 20, a map database 25, a registration database 26, and a connection bus 27.

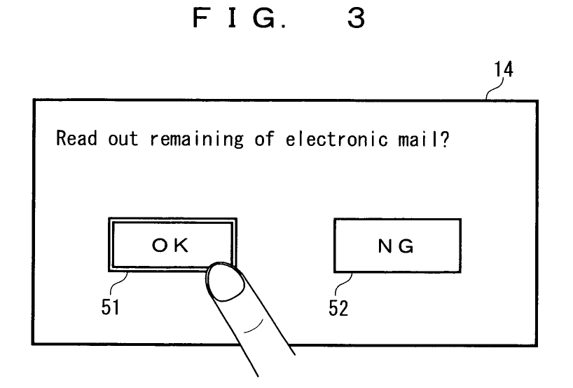

The GPS (Global Positioning System) receiver 11 receives GPS information (including position information and time information) via the antenna 12. The autonomous navigation sensor 13 has an angular sensor and a distance sensor (both are not shown) and is used with the GPS receiver 11 for specifying a current position of a vehicle. The display 14 displays various operation screens (see FIG. 3) as needed and displays guidance information when the device is used in route guidance. The display 14 is also used to display the content (a title, received date and time, information about a mail source, and an electronic mail text). The touch panel 15 has a matrix switch provided to overlap on the display 14 and detects a contact by a finger or the like. In the embodiment, the touch panel 15 is used mainly for operation on the above-mentioned various operation screens. The speaker 16 notifies a user (driver) that an electronic mail has been received and the text thereof audibly. Further, the speaker 16 notifies various pieces of audio confirmation (audio guidance urging the user to select or confirm) as needed, and outputs audio guidance information when the device is used in the route guidance.

The microphone 18 is used for various operations in handsfree and is used for selection operations and the like as the touch panel 15. Also, the microphone 18 is used for handsfree call when a portable device 30 is a mobile phone. The communication section 19 performs a close range wireless communication or an infra-red communication with the portable device 30. In this embodiment, the communication section 19 is mainly used for obtaining an electronic mail. The communication section 19 may employ a cable communication such as a bus connection in place of these non-contact communications.

The control section 20 includes a CPU (Central Processing Unit) 21, a ROM (Read Only Memory) 22, a RAM (Random Access Memory) 23 and an audio processing section 24. The CPU 21 is a central processing unit and processes various calculations. The CPU 21 has a timer (especially, not shown) which times current time. The ROM 22 stores a control program for processing the various calculations by the CPU 21, and the RAM 23 is used as work area when the CPU 21 processes the various calculations.

The audio processing section 24 performs a generation process of audio information for reading out a text of an electronic mail, a combination process of the audio information and guidance information and the like. Further, the audio processing section 24 has a speech speed conversion unit 24a and determines a reading-out speed (output speed) of an electronic mail in accordance with output length (referred as “mail output length” hereinbelow) of an electronic mail text or the like. A specific process of the audio processing section 24 will be explained later. In the description later, a mode in which a text is read out at a normal reading-out speed is referred as a “normal reading-out mode” and a mode in which a text is read out at a speed faster than the normal reading-out speed is referred as a “fast reading-out mode”. The audio processing section 24 (speech speed conversion unit 24a) determines (converts) the reading-out speed based on setting one of these reading-out modes by the CPU 21.

The map database 25 stores map data for route guidance in non-volatile. The registration database 26 stores spot registration information in which spots have been registered and various pieces of setting/registration information. In the vehicle-mounted device 10 of the invention, a reference value for setting one of the reading-out modes above by the CPU 21, which algorithm should be used for reading out the text of an electronic mail and the like (details will be explained later) can be set, and the setting values of such various mail settings are also registered in the registration database 26.

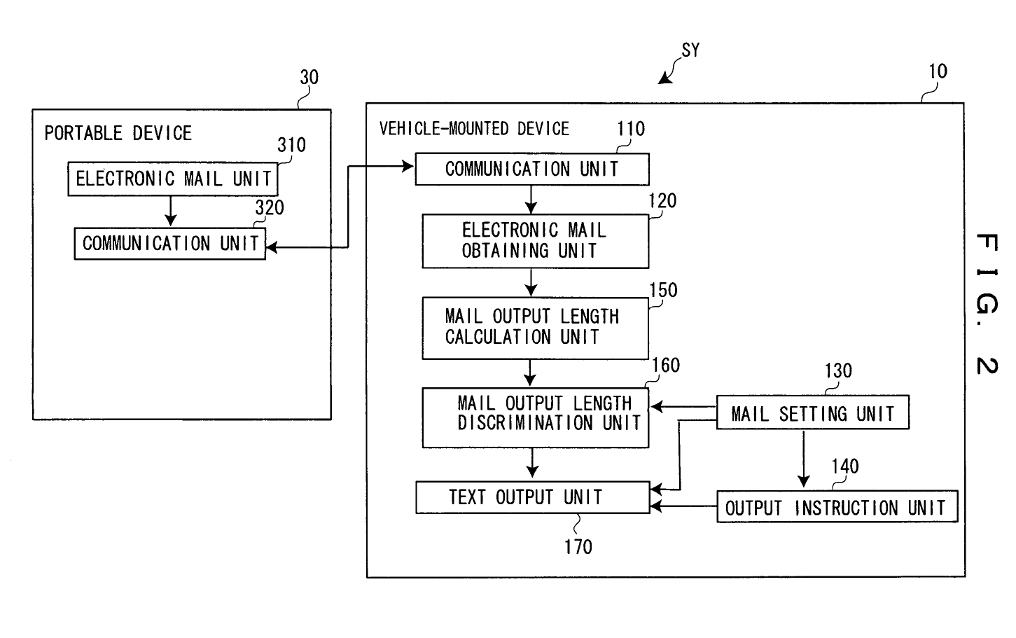

Referring to FIG. 2, a function structure of an information communication system SY having the vehicle-mounted device 10 and the portable device 30 will be explained. The portable device 30 has an electronic mail unit 310 and a communication unit 320 as main functional components.

The electronic mail unit 310 performs an electronic mail function by the portable device 30 and includes an electronic mail reception unit, an electronic mail generation unit and an electronic mail transmission unit. The electronic mail unit 310 also includes a mail ID provision unit for providing a mail ID identifying each electronic mail to received electronic mails. The communication unit 320 performs input/output (transmission/reception) of information with the vehicle-mounted device 10, and, in the embodiment, is mainly used for transfer of an electronic mail and reception of output completion information (information indicating the mail ID of an output electronic mail and an output completed portion thereof). When the portable device 30 receives the output completion information from the vehicle-mounted device 10, the electronic mail unit 310 performs an already-read process. More specifically, it renders the output completed portion of the electronic mail specified by a mail ID in an already-read state (displays an already-read portion and an unread portion identifiably). In a case that the output of an electronic mail as a whole has been completed, the electronic mail itself is rendered in the already-read state (stop handling as unread mail).

By contrast, the vehicle-mounted device 10 includes a communication unit 110, an electronic mail obtaining unit 120, a mail setting unit 130, an output instruction unit 140, a mail output length calculation unit 150, a mail output length discrimination unit 160 and a text output unit 170 as main function structures.

The communication unit 110 performs input/output of information with the portable device 30. The electronic mail obtaining unit 120 is used to obtain the electronic mail from the portable device 30 via the communication unit, the mail being received by the portable device 30. The communication unit 110 and the electronic mail obtaining unit 120 have the communication section 19 as main structure element.

The mail setting unit 130 sets a reference value for discrimination by the mail output length discrimination unit 160 and which algorithm should be used to read out the text of an electronic mail by the text output unit 170, and have the control section 20, the display 14, the touch panel 15, the speaker 16 and the microphone 18 as main structure elements. In other words, the mail setting unit 130 may display a screen by which a user is urged to set the reference value and the algorithm on the display 14, or may output audio guidance which urges to the user to set the setting through the speaker 16. While, the user may perform a setting operation with the touch panel 15 or the microphone 18. Setting values by the mail setting unit 130 are registered in the registration database 26.

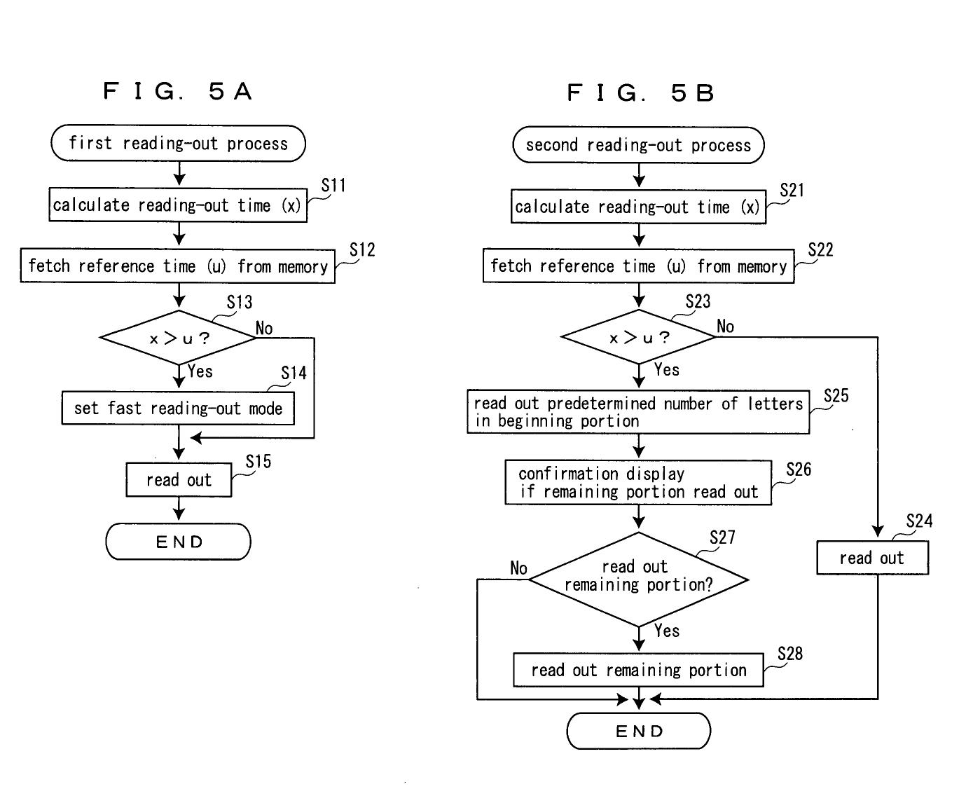

A setting content by the mail setting unit 130 is specifically explained. The phrase of “a reference value for discrimination by the mail output length discrimination unit 160” indicates minimum output length (predetermined output length) of an electronic mail text adopted with the fast reading-out (see FIG. 5A) and the partial reading-out speed (see FIG. 5B). When mail output length is below the predetermined output length, a whole text is read out at a normal speed. The term of the “mail output length (text output length of an electronic mail)” refers to the size of a display area or display time needed for displaying the text of an electronic mail, or output time needed for outputting the text of an electronic mail audibly. The size of the display area and the output time can be calculated by a predetermined algorithm having the number of letters (may include characters such as pictograms and signs, letters included in an attached file) included in an electronic mail, data amount, existence/non-existence of an attached file and the like as parameters.

The term of the “algorithm” refers to the first algorithm by which a text is output at the speed faster than the normal speed when the mail output length is beyond the predetermined output length, the second algorithm by which only the beginning portion of the text is output when the mail output length is beyond the predetermined output length, etc. In the embodiment (the first embodiment), one of the above algorithms may be selected (the first reading-out process: see FIG. 5A, the second reading-out process: see FIG. 5B). In other embodiments, other reading-out algorithms (reading-out processes) will be exemplified, but one of more than three algorithms including the above algorithms may be set in the mail setting unit 130.

The output instruction unit 140 instructs to output the remaining portion of an electronic mail when the second algorithm has been set by the mail setting unit 13 and only the beginning portion of an electronic mail has been output, and has the display 14 and the touch panel 15 as main structure elements. FIG. 3 shows an instruction display example. A user selects whether the remaining portion of an electronic mail text should be output (read out) by touching one of icons 51 and 52 displayed on the display 14. The output instruction unit 140 may be set preliminarily in an environment settings or the like, not after reading out the beginning portion. In this case, when “outputting the remaining portion” is set, the whole text of an electronic mail becomes an output target regardless of the mail output length.

The output instruction by the output instruction unit 140 may be audio guidance and an instruction by a user's voice. In short, whether the remaining portion of an electronic mail is read out is guided with the voice, and a determination is made with the voice instruction of “YES” or “NO” from the user. In this case, the output instruction unit 140 has the speaker 16 and the microphone 18 as main elements.

The mail output length calculation unit 150 calculates the mail output length obtained by the electronic mail obtaining unit 120, and the mail output length discrimination unit 160 discriminates whether the mail output length (for example, in a case of audio output, “60 seconds” or the like) calculated by the mail output length calculation unit 150 is more than the predetermined output length set by the mail setting unit 130. These mail output length calculation unit 150 and the mail output length discrimination unit 160 have the control section 20 as main structure element. Further, the text output unit 170 displays or outputs audibly the electronic mail text in accordance with a discrimination result of the mail output length discrimination unit 60, and has the control section 20, the display 14 and the speaker 16 as main elements.

Also, the text output unit 170 outputs the electronic mail text based on the algorithm set by the mail setting unit 130 (performs the first reading-out process or the second reading-out process). In a case that the second algorithm is set by the mail setting unit 130 and the output instruction unit 140 instructs, the remaining portion other than the beginning portion of an electronic mail is displayed or output audibly. Though the text output unit 170 is capable of outputting the electronic mail text through the display 14 and/or the speaker 16, in the explanation below, the output (audio output) through the speaker 16 will be mainly explained. Further, “outputting audibly” may be paraphrased as “reading out” arbitrarily.

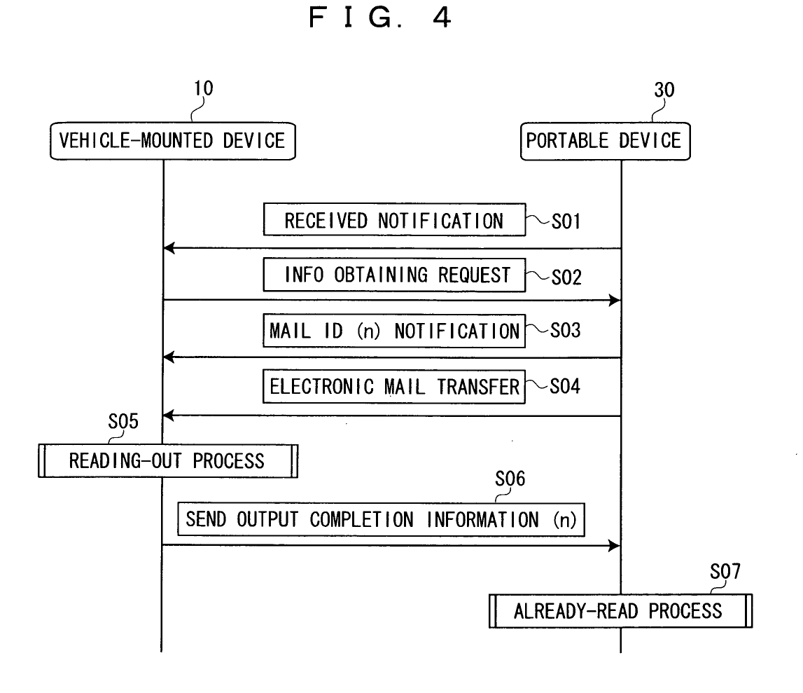

Referring to the sequence diagram of FIG. 4, an outline of the electronic mail reading-out process between the vehicle-mounted device 10 and the portable device 30 will be explained. As shown in FIG. 4, when the vehicle-mounted device 10 obtains a received notification which indicates reception of an electronic mail (S01), it sends back an information obtaining request to the portable device 30 (S02). In response, the portable device 30 notifies the mail ID of the electronic mail which has been notified (S03) and transfers the electronic mail (various pieces of information including the electronic mail text) (S04).

When receiving the electronic mail, the vehicle-mounted device 10 performs the reading-out process (S05), and sends the output completion information to the portable device 30 when the reading-out process terminates (or the reading-out process is interrupted by any reason). At this moment, the output completion information is added with the mail ID of the electronic mail. When obtaining the output completion information from the vehicle-mounted device 10, the portable device 30 performs the already-read process of the electronic mail based on the information (S07). In the case that the reading-out process is interrupted by any reason, the output completion information indicates that the output completed portion at the time of interruption is rendered in the already-read state.

Referring to the flowcharts of FIGS. 5A and 5B, the reading-out process will be explained. FIG. 5A shows the first reading-out process based on the first algorithm, and FIG. 5B shows the second reading-out process based on the second algorithm. In the flowcharts, since the reading-out process (output by audio) is supposed to be done, the reference value for the fast reading-out and reading-out the beginning portion (predetermined output length of the electronic mail text) is referred as “reference time”.

As shown in FIG. 5A, in the first reading-out process, reading-out time (x) needed for reading out the whole text of the electronic mail transferred from the portable device 30 is calculated (S11). Then, the reference time (u) is fetched from the memory (registration database 26) and whether the reading-out time (x) is beyond the reference time (u) is discriminated. In a case that the reading-out time (x) exceeds the reference time (u) (S13: Yes), the fast reading-out mode is set (S14) and the text of the electronic mail is read out (S15). On the other hand, the reading-out time (x) is not beyond the reference time (u) (S13: No), the text of the electronic mail is read out (S15), without setting the fast reading-out mode (in the normal reading-out mode).

The second reading-out process will be explained. In the second reading-out process, as the first reading-out process, the reading-out time (x) of the electronic mail is calculated (S21), the reference time (u) is fetched from the memory (registration database 26) (S22), and whether the reading-out time (x) is beyond the reference time (u) is discriminated (S23). In the case that the reading-out time (x) does not exceed the reference time (u) (S23: No), the text of the electronic mail is read out (S24) at a normal reading-out speed (normal speed). On the other hand, the reading-out time (x) exceeds the reference time (u) (S23: Yes), only the predetermined number of letters in the beginning portion of the electronic mail is read out at the normal speed (S25) and the display 14 displays by which a user is urged to decide whether the remaining portion thereof should be read out (S26: see FIG. 3). In a case that an instruction to read out the remaining portion is made (S27: Yes), the remaining portion is read out at the normal speed (S28). In a case that the instruction to read out the remaining portion is not made (S27: No), the reading-out process ends without reading out the remaining portion thereof.

In FIG. 5A, the reading-out speed is set in two stages depending on whether the reading-out time (x) is beyond the reference time (u) or not, but the reading-out speed may be set in more stages by providing a plurality of reference time.

In FIG. 5B, in the case that the reading-out time (x) is beyond the reference time (u), only the predetermined number of letters in the beginning portion is read out (see S25), but the predetermined number of letters may be set by the mail setting unit 130. It may be also possible to read out an amount having a predetermined ratio such as a former portion (½ of the whole text) when the electronic mail is divided in half of the electronic mail text, in place of reading out only the predetermined number of letters. Further, it may be possible to read out until the end (period) of a sentence in the predetermined number of letters only, or until the end of a sentence in which the last word of the predetermined number of letters is included.

As explained above, according to the first embodiment, it is possible to set a reading-out algorithm of an electronic mail based on user's preference and needs. Further, when the first algorithm is set and mail output length is beyond predetermined output length, it is easily possible to shorten time for output only by changing the reading-out speed by the speech speed conversion unit 24a. Also, when the second algorithm is set, it is possible to effectively notify a driver the content of an electronic mail in a short time since a beginning portion which tends to include the important content (summary) of an electronic mail is output even when the mail output length is long. Further, it is convenient since whether the remaining portion other than the beginning portion should be output is instructed based on a user's decision.

In addition to a discrimination result of the mail output length discrimination unit 160, the text of an electronic mail may be read out based on importance degree of the electronic mail. In this case, an importance degree discrimination unit (not shown) which discriminates importance degree of an electronic mail is provided in the function structure of the vehicle-mounted device 10 in FIG. 2, and the text output unit 170 reads out the text of an electronic mail based on a discrimination result of the mail output length discrimination unit 160 and the importance degree of an electronic mail discriminated by the importance degree discrimination unit. For example, in a case that the importance degree of an electronic mail is high and the first reading-out process is employed, a normal reading-out speed may be used even when mail output length is long. In a case that the second reading-out process is employed, that the mail has high importance degree (important mail) may be notified when the beginning portion is read out. With this configuration, it is possible to display or output audibly in accordance with the importance degree of an electronic mail.

The importance degree of an electronic mail can be discriminated based on at least a piece of information such as a priority flag added to the electronic mail, a sender's address and existence/nonexistence for breaking a seal confirmation. For example, in terms of the “sender's address”, an address including a predetermined character string may be discriminated as having high degree of importance. Further, the degree of importance may be discriminated in accordance with whether the sender's address has been stored or not in the telephone book (address book) stored in the portable device 30 or the vehicle-mounted device 10. The importance degree may be discriminated at the vehicle-mounted device 10 based on information obtained with the electronic mail sent from the portable device 30 or obtained before/after the reception of the electronic mail. Also, the discrimination result discriminated based on these pieces of information at the portable device 30 may be obtained by the vehicle-mounted device 10. In the latter case, the importance degree discrimination unit discriminates degree of importance based on the discrimination result obtained from the portable device 30.

The text output unit 170 may read out the text of an electronic mail based on the mail output length calculated by the mail output length calculation unit 150 and the importance degree of the electronic mail discriminated by the importance degree discrimination unit. In other words, an output method such that an electronic mail text is read out at an output speed proportional to mail output length may be employed, in place of whether the mail output length is beyond the predetermined output length.

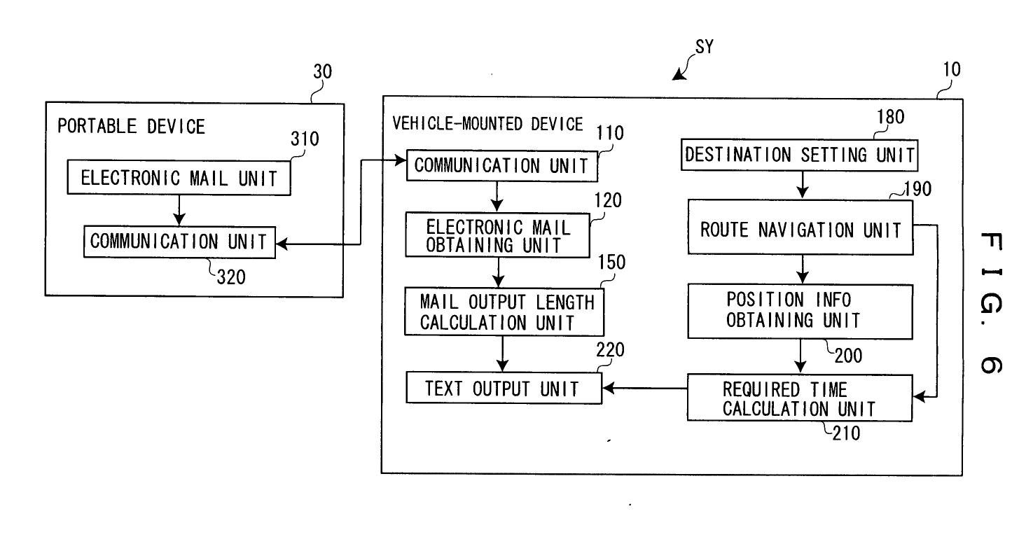

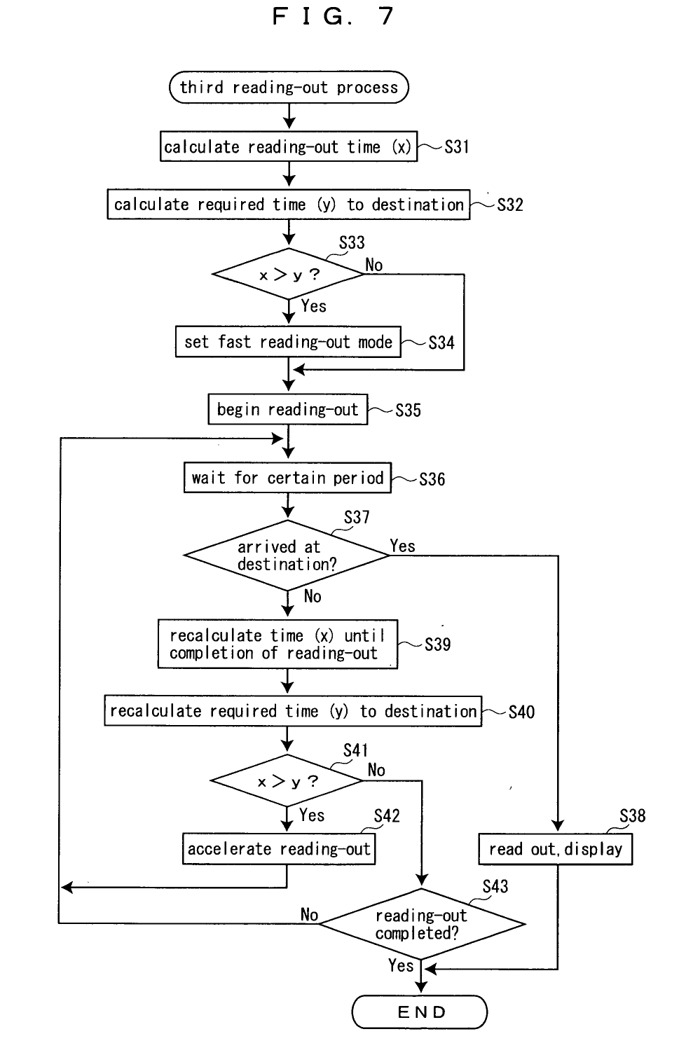

The second embodiment of the invention will be explained with reference to FIGS. 6 and 7. In the first embodiment above, the electronic mail text is read out based on whether the mail output length is beyond the predetermined output length, while, the present embodiment differs in that the electronic mail text is read out based on required time needed for driving from a current location to a destination. The different aspect from the first embodiment will be explained hereinbelow.

FIG. 6 shows a functional block diagram of an information communication system SY according to the second embodiment. The structure of the portable device 30 is the same as that in the first embodiment and the explanation thereof will be omitted. Further, regarding the vehicle-mounted device 10, structure elements having the same function as those in the first embodiment are referred with the same numbers and the explanation thereof will be omitted.

The vehicle-mounted device 10 has, as main function structures, the communication unit 110, the mail information obtaining unit 120, the mail output length calculation unit 150, a destination setting unit 180, a route guidance unit 190, a position information obtaining unit 200, a required time calculation unit 210 and a text output unit 220.

The destination setting unit 180 sets a destination of a vehicle and has the control section 20 and the map database 25 as main structure elements. The route guidance unit 190 searches a route to the destination set by the destination setting unit 180 and guides the route (including route guidance display and audio guidance) and has the autonomous navigation sensor 13, the control section 20 and the map database 25 as main structure elements. The position information obtaining unit 200 obtains position information indicating the current position of the vehicle and has the GPS receiver 11 as main structure element. The route guidance unit 190 guides a route based on the position information obtained from the position information obtaining unit 200.

The required time calculation unit 210 calculates required time for a vehicle from the current location corresponding to the position information obtained from the position information obtaining unit 200 to the destination set by the destination setting unit 180 based on the route search result by the route guidance unit 190, and has the control section 20 as main structure element. A known technique can be applied for a calculation algorithm for the required time. In a case that there are a plurality of driving routes to the set destination, the required time is calculated after the user operates to select one of the driving routes.

The text output unit 220 reads out the text of an electronic mail based on the mail output length (reading-out time) calculated by the mail output length calculation unit 150 and the required time calculated by the required time calculation unit 210. More specifically, a reading-out speed is determined such that the text of the electronic mail can be read out within the required time. The reading-out speed is changed as needed based on a comparison result by periodically comparing a time needed for completion of reading-out and a required time to a destination, because the required time varies due to a driving speed or a traffic-jam state, or due to a situation that the reading-out can not be completed at a reading-out speed of the beginning of driving until the vehicle arrives at a destination.

Referring to the flowchart of FIG. 7, one example (the third reading-out process) of the reading-out process according to the second embodiment will be explained. In the third reading-out process, the reading-out time (x) of an electronic mail is calculated (S31), and the required time (y) to a destination is further calculated (S32). Whether the reading-out time (x) is beyond the required time (y) is discriminated (S33). Whether the reading-out time (x) exceeds the required time (y) (S33: Yes), the fast reading-out mode is set (S34), and the reading-out begins (S35). While, the reading-out time (x) is not beyond the required time (y) (S33: No), the reading-out begins at the normal speed (S35).

The process waits for a predetermined period of time (continues to read out: S36) and discriminates whether the vehicle arrives at the destination (S37). The waiting period is counted by a timer (not shown) in the CPU 21. In a case that the vehicle arrives at the destination (S37: Yes), the remaining portion other than the portion which has been already read out in the text of the electronic mail is read out and is displayed on the display 14 (S38). Thus, after the vehicle has arrived at a destination, there is no need to care about a safety aspect, and a driver can quickly and accurately confirm the content of the electronic mail by outputting the electronic mail on the display and by the audio output. In the case that “the remaining portion of the electronic mail” is output after the vehicle has arrived at the destination, it is preferable that the output begin from the beginning of a sentence to which the initial letter of the remaining portion belongs or from the beginning of a paragraph to which the initial letter of the remaining portion belongs. With this configuration, it is possible to avoid a sense of discomfort and false recognition caused by outputting from the middle of a sentence.

On the other hand, in a case that the vehicle has not arrived at the destination yet (S37: No), the time (x) until the reading-out completes is recalculated (S39) and the required time (y) to the destination is recalculated (S40). Then, whether the time (x) until the reading-out completes is beyond the required time (y) is discriminated (S41). When the time (x) until the reading-out completes exceeds the required time (y) (S41: Yes), the reading-out speed is accelerated (S42) and S36-S41 are repeated. When the time (x) does not exceed the required time (y) (S41: No), whether the reading-out completes or not is discriminated (S43). When the reading-out completes (S43: Yes), the reading-out process terminates. While, the reading-out has not been completed (S43: No), S36-S41 are repeated.

As described above, according to the second embodiment, it is possible to read out the text of an electronic mail at an appropriate reading-out speed based on the calculated mail output length and the required time to a destination. Thus, it is possible to solve the problem in which a driver has to confirm the output of an electronic mail text even if the vehicle has arrived at a destination.

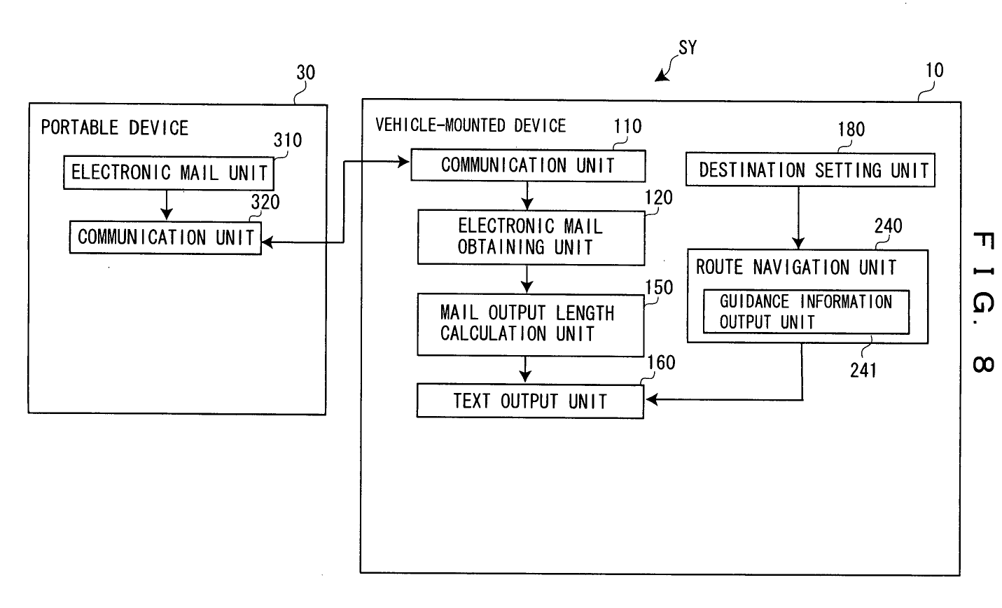

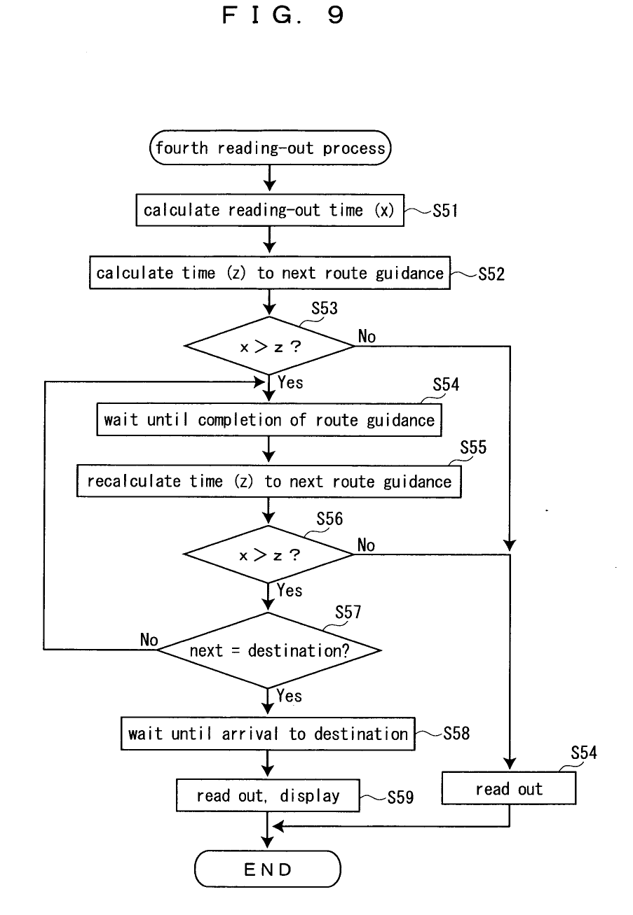

Referring to FIGS. 8 and 9, the third embodiment of the invention will be explained. In the second embodiment, the reading-out of the electronic mail text is done based on the required time for driving to the destination, but the embodiment differs in that the reading-out of an electronic mail text is done based on output timing (route guidance timing) of guidance information. Further, the embodiment differs in that a reading-out speed is not changed. Points different from the second embodiment will be mainly explained hereinbelow.

FIG. 8 is a functional block diagram of an information communication system SY according to the third embodiment. The vehicle-mounted device 10 of the third embodiment has, as main function structures, the communication unit 110, the electronic mail obtaining unit 120, the mail output length calculation unit 150, the destination setting unit 180, a route guidance unit 240 and a text output unit 250.

The route guidance unit 240 is similar to that of the second embodiment in that it guides a route to the destination set by the destination setting unit 180, but the route guidance unit 240 of the embodiment includes a guidance information output unit 241 which displays or outputs audibly the guidance information at predetermined output timing. The “guidance information” includes route guidance information such as “turn right at 300 m ahead” and “right direction soon”, time guidance information such as “three o'clock”, and traffic information such as “traffic jam 300 ahead”. The output of the guidance information is simply referred as “route guidance” hereinafter. The “route guidance timing” is stored as a timetable. The time table (route guidance timing) is edited as needed based on a traffic jam state and driving speed while a vehicle is moving. Thus, inaccurate route guidance can be avoided.

The text output unit 250 read out the text of an electronic mail based on the mail output length calculated by the mail output length calculation unit 150 and the output timing of the guidance information. More specifically, in a case that the output of the electronic mail text overlaps with the output timing of the guidance information, the electronic mail text is output after the guidance information has been output.

Referring to the flowchart of FIG. 9, one example (the fourth reading-out process) of the reading-out process according to the third embodiment will be explained. In the fourth reading-out process, the reading-out time (x) of an electronic mail is calculated (S51), and time (z) to the next route guidance is calculated (S52). Whether the reading-out time (x) is beyond the time (z) to the next route guidance is discriminated (S53), and when the reading-out time (x) does not exceed the time (z) to the next route guidance (S53: No), the reading-out is done (S54). If the reading-out time (x) is beyond the time (z) to the next route guidance (S53: Yes), the process waits until the route guidance completes (S54) and recalculates the time (z) to the next route guidance (S55).

Whether the reading-out time (x) is beyond the time (z) to the next route guidance is discriminated again (S56), and when the reading-out time (x) does not exceed the time (z) to the next route guidance (S56: No), the reading-out is done (S54). When the reading-out time (x) exceeds the time (z) to the next route guidance (S56: Yes), whether the next route guidance is the route guidance which indicates arrival to a destination or not is discriminated (S57). In a case that the next route guidance is not the route guidance indicating the arrival to the destination (S57: No), S54-S56 are repeated. While, in a case that the next route guidance is the route guidance indicating the arrival to the destination (S57: Yes), the process waits until the arrival to the destination and reads out the text of the electronic mail and displays it on the display 14 (S59). Thus, after arriving at a destination, the process outputs an electronic mail on the display and by the audio output to inform the content of the electronic mail quickly and accurately to a driver.

In the flowchart above, the reading-out time (x) needed for reading out completion and the time (z) to the next route guidance is compared, and when x>z, the electronic mal text is not read out, but the text may be read out as possible during the time (z) to the next route guidance. In this case, by setting the fast reading-out mode, the text may be read out at a faster speed than the normal speed. In these cases, it is preferable that the reading-out be made per sentence or per paragraph.

Further, in the case that the text is read out as possible until the time (z) to the next route guidance, and the text of an electronic mail is read out and displayed after the arrival (see S59), it is preferable that the reading-out begin from the beginning of a sentence to which the initial letter of the remaining portion belongs or the beginning of a paragraph to which the initial letter of the remaining portion belongs, to avoid a sense of discomfort and false recognition as the second embodiment.

As described above, according to the third embodiment, it is possible to avoid exerting influence on the information outputs to each other by outputting the text of an electronic mail based on the mail output length and the route guidance timing. Further, since route guidance timing can not be changed in many cases, it is possible to avoid inaccurate route guidance (giving a sense of discomfort) by adjusting output timing of the electronic mail text.

In the above embodiment, when the reading-out of the electronic mail text overlaps with the route guidance timing (x>z), the electronic mail text is read out after the route guidance, but the reading-out of the electronic mail text may be done before the route guidance. In other words, the route guidance may be done after the electronic mail text (whole text) has been read out. Also, in this case, the text may be read out at a speed faster than the normal speed by setting the fast reading-out mode. If the route guidance timing is untimely, information might be inaccurate. In such a case, it is preferable that the context of the route guidance be edited. For example, in a case that route guidance of “turn right 300 m ahead” is to be output at a predetermined timing (predetermined time) and it takes for a while due to waiting for reading out the electronic mail text, it is possible to correspond by editing the route guidance as “turn right 100 m ahead”.

Thus, three embodiments have been explained, but each embodiment is not necessarily achieved independently and a structure having combination of each embodiment may be taken. For example, in the second and the third embodiment, the device may have an importance degree discrimination device (not shown) which discriminates importance degree of an electronic mail, and the electronic mail text may be output based on the mail output length, a predetermined condition corresponding to a destination (required time to the destination and/or route guidance timing) and degree of importance. For example, when the importance degree of an electronic mail is high, an output method such that the text is read out with turned up volume or a reading-out speed is increased and the like compared with an electronic mail having low degree of importance may be adopted. Also, when the importance degree of an electronic mail is high, an output method such that that (the mail is important) is notified at the beginning of reading-out, the text is read out without avoiding the route guidance timing, reading-out of the electronic mail is prioritized than the route guidance and the like may be employed. Further, in the second embodiment and the third embodiment, the device may have the mail output length discrimination unit 160 (see FIG. 2) mentioned in the first embodiment and when the mail output length is beyond the predetermined output length, the beginning portion of the electronic mail text may be output. In this case, the predetermined output length may be changed based on required time to the destination and/or route guidance timing.

Still further, in the above three embodiments, the vehicle-mounted device 10 obtains an electronic mail by being transferred from the portable device 30 having the electronic mail function, but the electronic mail may be obtained by receiving the electronic mail directly. In this case, the vehicle-mounted device 10 has an “electronic mail reception unit (not shown)” in place of the communication unit 110 and the electronic mail obtaining unit 120 obtains the electronic mail received by the “electronic mail reception unit”.

Still further, in the embodiments above, the reading-out speed or the reading-out timing is changed based on the calculation result of the mail output length, the importance degree of the electronic mail, the required time to the destination, the route guidance timing (the output timing of the guidance information) and the like, but other than those, an output order, output volume, output audio and the like may be changed.

Still further, in the embodiments above, the text output units 170, 220 and 250 output the electronic mail text by audio output (reading-out), but instead of the output or with the output, the electronic mal text may be displayed on the display 14. In this case, the electronic mail text may be run a telop (movie display) or may be displayed in a stop motion. In the latter case, it is possible to switch screen manually or to display like a slide show. A user may set a display method as the user likes. When the output is done by displaying, it is preferable that at least one factor among existence/non-existence of output, output target limitation, an output speed and output configuration (an output order, output size, letter decoration) be changed.

Still further, it is possible to provide each structure element in the vehicle-mounted device 10 and the portable device 30 as program. Also, it is possible to provide a recording medium (not shown) in which the program has been stored. In short, the scope of the invention includes a program causing a computer to function as each structure element of the vehicle-mounted device 10 and the portable device 30, and a recording medium recorded the program therein. Modifications may be possible without departing from the scope of the invention.

### REFERENCE NUMERALS

10: vehicle-mounted device
11: GPS receiver
12: antenna
13: autonomous navigation sensor
14: display
15: touch panel
16: speaker
18: microphone
19: communication section
20: control section
21: CPU
22: ROM
23: RAM
24: audio processing section
24a: speech speed conversion unit
25: map database
26: registration database
27: connection bus
SY: information communication system

1. A vehicle-mounted device comprising:
an electronic mail obtaining unit that obtains an electronic mail from a portable device having an electronic mail function;
a text output unit that displays or outputs audibly the obtained electronic mail text; and
an output completion information sending unit that sends output completion information indicating a mail ID of the output electronic mail to the portable device;
wherein the output completion information is information that renders the electronic mail corresponding to the mail ID in an already-read state in accordance with receiving the output completion information by the portable device.

2. The vehicle-mounted device according to claim 1, wherein the output completion information is information that renders an output completed portion of the electronic mail corresponding to the mail ID in the already-read state.

3. The vehicle-mounted device according to claim 1 further comprising a mail output length calculation unit that calculates mail output length which is output length of the obtained electronic mail text; and a destination setting unit that sets a destination; wherein the text output unit that displays or outputs audibly the electronic mail text based on the mail output length calculated by the mail output length calculation unit and a predetermined condition corresponding to the destination set by the destination setting unit.

4. The vehicle-mounted device according to claim 3 further comprising a required time calculation unit that calculates required time for driving from a current position to the set destination, wherein the predetermined condition is the required time calculated by the required time calculation unit.

5. The vehicle-mounted device according to claim 3 further comprising a route guidance unit that guides a route to the set destination, wherein the route guidance unit has a guidance information output unit that displays or outputs audibly guidance information at predetermined output timing and the predetermined condition is the output timing of the guidance information.

6. The vehicle-mounted device according to claim 5, wherein the text output unit outputs the electronic mail text before or after the guidance information when output of the electronic mail text overlaps with the output timing of the guidance information.

7-9. (canceled)

10. The vehicle-mounted device according to claim 3, wherein the text output unit displays or outputs audibly a remaining portion other than output completed portion of the electronic mail after arriving at the destination when the electronic mail text output has not been completed by the arrival to the destination.

11. The vehicle-mounted device according to claim 10, wherein the text output unit begins to output from a beginning of a sentence or a paragraph to which an initial letter of the remaining portion belongs when the remaining portion of the electronic mail is output.

12. The vehicle-mounted device according to claim 3 further comprising an importance degree discrimination unit that discriminates importance degree of the electronic mail, wherein the text output unit displays or outputs audibly the electronic mail text based on the mail output length, the predetermined condition and the importance degree discriminated by the importance degree discrimination unit.

13. The vehicle-mounted device according to claim 12, wherein the importance degree discrimination unit discriminates the importance degree of the electronic mail based on at least one pieces of information among a priority flag added to the electronic mail, a sender's address and existence/nonexistence for breaking a seal confirmation.

14. The vehicle-mounted device according to claim 3 further comprising a mail output length discrimination unit that discriminates whether the calculated mail output length exceeds predetermined output length, wherein the text output unit displays or outputs audibly only a beginning portion of the electronic mail text when the mail output length exceeds the predetermined output length.

15. The vehicle-mounted device according to claim 14 further comprising an output instruction unit that instructs to output a remaining portion other than the beginning portion of the electronic mail text, wherein the text output unit displays or outputs audibly the remaining portion when the output instruction unit instructs.

16. An information communication system comprising the vehicle-mounted device according to claim 1 and the portable device.

17. A method for controlling a vehicle-mounted device having an electronic mail obtaining function, the vehicle-mounted device executing steps of:
obtaining an electronic mail;
calculating mail output length that is output length of the obtained electronic mail text;
setting a destination; and
outputting by displaying or outputting audibly the electronic mail text based on the mail output length by calculating the mail output length and a predetermined condition corresponding to the destination by setting the destination.

18. A computer readable medium encoded with a computer program for causing a computer to perform each step in the communication control method of the communication device as set forth in claim 17.
